(19) United States
(12) Patent Application Publication
(10) Pub. No.: US 2012/0048926 A1
(43) Pub. Date: Mar. 1, 2012

(54) CODE READING APPARATUS, CODE READING SYSTEM, AND CODE READING METHOD

(75) Inventors: Hidehiro Naito, Shizuoka (JP); Tomonari Kakino, Shizuoka (JP)

(73) Assignee: TOSHIBA TEC KABUSHIKI KAISHA, Tokyo (JP)

(21) Appl. No.: 13/216,425

(22) Filed: Aug. 24, 2011

(30) Foreign Application Priority Data
Aug. 26, 2010 (JP) 2010-189751

(51) Int. Cl. G06K 15/00

(52) U.S. Cl. 235/383

(57) ABSTRACT

According to one embodiment, includes a photographing unit, a detection unit, a reading unit and a display control unit. The photographing unit photograph an image. The detection unit detect the code symbol of a commodity-specific information of a specific commodity that is recorded in sales based on the photographed image. The reading unit read the commodity-specific information from the detected code symbol. The display unit display the information related to a commodity specified by the read commodity-specific information. The display control unit change the display mode of the display unit if the read commodity-specific information is the same as the commodity-specific information of a specific commodity that is recorded in sales in the same transaction.

### CROSS-REFERENCE TO RELATED APPLICATION

This application is based upon and claims the benefit of priority from the prior Japanese Patent Application No. 2010-189751, filed on Aug. 26, 2010, the entire content of which is incorporated herein by reference.

### TECHNICAL FIELD

Embodiments described herein relate generally to a code reading apparatus, a code reading system, and a code reading method.

### BACKGROUND

The code reading apparatus conventionally used in a supermarket and like locations photographs the bar code or two-dimensional code (e.g. QR code (registered trademark)) and other code symbols added on a commodity via a charge coupled device (CCD) imaging sensor or other digital cameras, detects a code symbol according to the photographed image, and reads a commodity code from the detected code symbol. A cashier takes out each commodity from the shopping basket placed by a customer on a counter and then aims the commodity at the digital camera of the code reading apparatus to register the commodities the customer purchases.

In the case where the commodity code of the same commodity is read twice by the conventional reading apparatus, the repeated reading can only be confirmed by checking a bill that is printed by a point of sales (POS) terminal after the commodity codes of all commodities are read. Therefore, in the case where the commodity codes of a plurality of commodities are read, it is difficult to confirm the repeated reading of the commodity code of the same commodity with the conventional code reading apparatus.

### DESCRIPTION OF THE DRAWINGS

FIG. 1 shows a perspective diagram of a cash register system;

FIG. 2 is a block diagram of the hardware structures of a POS terminal and a code reading apparatus;

FIG. 3 is a diagram of an example of the relationship between a commodity and the photographing area of a photographing unit;

FIG. 4 is a block diagram of the functional structure of a CPU installed in a code reading apparatus;

FIG. 5 is a diagram of an example of an image captured by a photographed image capturing unit;

FIG. 6 is a diagram of an example of an image displayed on a display;

FIG. 7 is a diagram of an example of away for changing the display mode of a display;

FIG. 8 is a diagram of another example of a way for changing the display mode of a display;

FIG. 9 is a diagram of another example of a way for changing the display mode of a display; and

FIG. 10 is a flowchart for explaining the output processing of commodity-specific information by a code reading apparatus according to an embodiment.

### DETAILED DESCRIPTION

According to one embodiment, includes a photographing unit, a detection unit, a reading unit and a display control unit. The photographing unit photograph an image. The detection unit detect a code symbol representing the commodity-specific information of a specific commodity that is recorded in sales based on the photographed image. The reading unit read the commodity-specific information from the detected code symbol. The display unit display the information related to a commodity specified by the read commodity-specific information. The display control unit change the display mode of the display unit if the read commodity-specific information is the same as the commodity-specific information of a specific commodity that is recorded in sales in the same transaction.

Based on an example of a cash register system configured with a POS terminal for the entry and detailed calculation of the commodities involved in a transaction, the code reading apparatus, system and method related to this embodiment are described below with reference to accompanying drawings. This embodiment is an applicable example of a cash register system introduced in a restaurant, supermarket, store and the like.

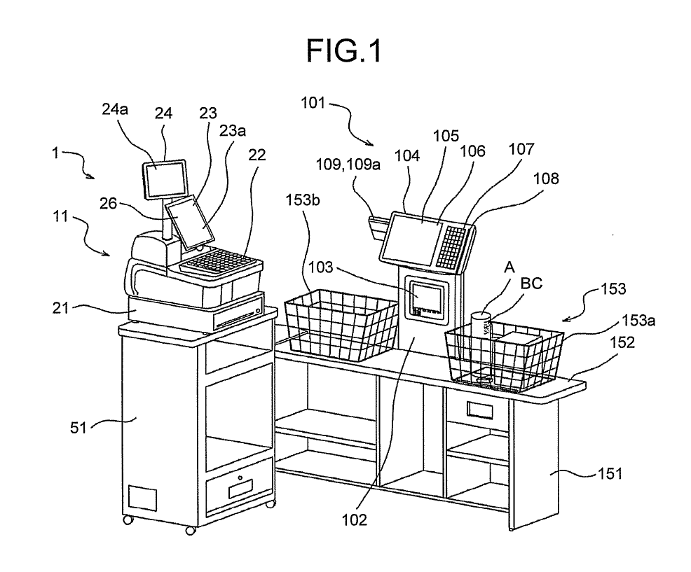

FIG. 1 shows a perspective diagram of a cash register system. As shown in FIG. 1, a cash register system 1 is configured with a POS terminal 11 that is placed on a cash box 21 on a checkout counter 51 for the entry and detailed calculation of the commodities involved in a transaction. Further, the POS terminal 11, which controls the opening of the cash box 21, has a keyboard 22 thereon for an operator (user) to press down. Seen from the operator of the keyboard 22, the POS terminal 11 is further configured with a display 23 behind the keyboard, the display 23 displaying, for the operator, information on a display surface 23a, and having a touch panel 26 that is laminated on the display surface 23a. Further, the POS terminal 11 still has a customer-oriented display 24 thereon which is located much further than the display 23 in a way of being capable of rotating freely and displays information on a display surface 24a. In addition, by rotating the display surface 24a from the front side shown in FIG. 1 to the back side shown in the same figure, information is displayed to a customer via the customer-oriented display 24 shown in FIG. 1.

In order to facilitate the forming of an L shape by the cash register system 1 with the checkout counter 51 holding the POS terminal 11, a counter 151 taking the shape of a rectangular desk is configured. The cash register system 1 is also configured with a support surface 152 on the counter 151 for a customer to place a shopping basket 153 in which commodities A affixed with bar codes are accommodated. The shopping basket 153 is divided into two types: a first customer-carried shopping basket 153a; and a second shopping basket 153b that is located away by the distance of the code reading apparatus 101 from the customer-carried shopping basket 153a.

The cash register system is further configured, on the support surface 152 of the counter 151, with a code reading apparatus 101 which is provided with a thin rectangular cover 102 and freely connected with the POS terminal 11 in data reception. A reading window 103 is configured on the front side of the cover 102 of the code reading apparatus 101. Moreover, the code reading apparatus 101 is also provided with a display/operation unit 104 on the upper portion of the cover 102, the display/operation unit 104 having a display 106 for laminating the touch panel 105 on the surface thereof. Further, the code reading apparatus 101 is provided with a keyboard 107 adjacent to the right side of the display 106 and the card reader slot 108 of a card reader (not shown) adjacent to the right side of the keyboard 107. Seen from an operator, the code reading apparatus 101 is provided with a customer-oriented display 109 on the right-rear side of the display/operation unit 104 to provide information to a customer. In addition, in the code reading apparatus 101, a customer-oriented touch panel 109a is laminated on the display surface of the customer-oriented display 109.

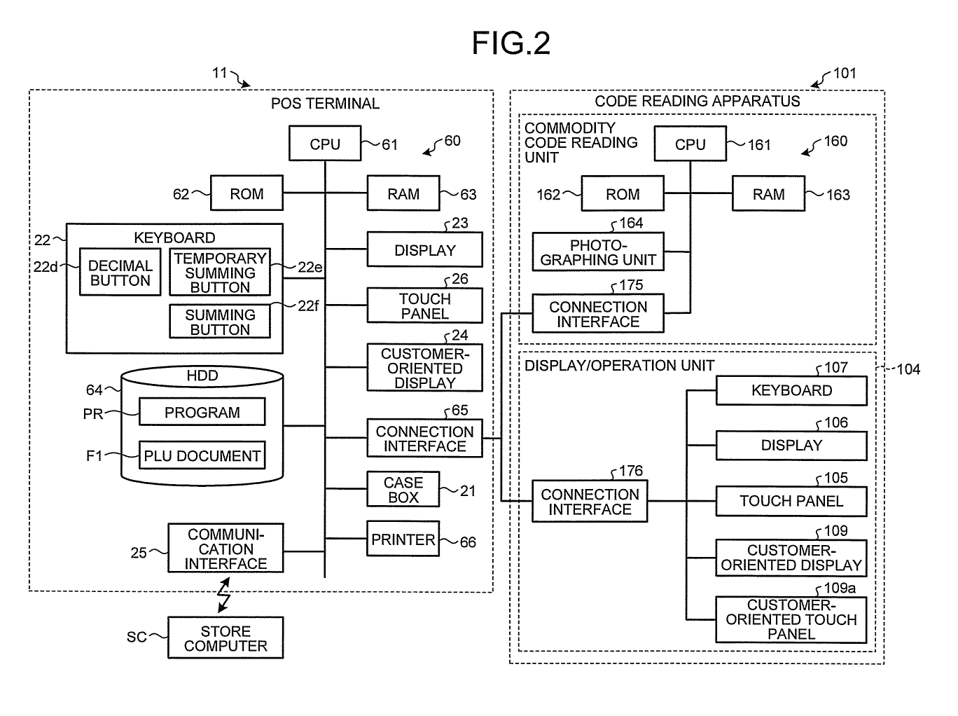

The first customer-carried shopping basket 153a is provided to accommodate the commodities involved in a transaction. In a store installed with the cash register system 1, a commodity A is affixed with a bar code BC to represent the commodity code thereof. An operator transfers the commodity A in the first shopping basket 153a into the second shopping basket 153b with the bar code BC facing the reading window 103 of the code reading apparatus 101. The photographing unit 164 (referring to FIG. 2) configured behind the reading window 103 photographs the bar code BC facing the reading window 103. The code reading apparatus 101 detects the bar code BC contained in the image photographed by the photographing unit 164 and reads the commodity-specific information, such as commodity code, of the specific commodity A from the detected BC. The commodity code read from the BC refers to the code that is allocated to each commodity for the specific commodity A, for example, a JAN code consisting of 13 numbers. Additionally, although the present invention is explained based on an example where the code symbol refers to a bar code, it should be appreciated that the code symbol may be a two-dimensional code such as a QR code (registered trademark).

FIG. 2 is a block diagram of the hardware structures of a POS terminal and a code reading apparatus. The POS terminal 11 is provided with a microcomputer 60 which serves as an information processing unit for processing information and is provided with a read only memory (ROM) 62, a random access memory (RAM) 63 on the CPU 61 of each unit for carrying out various operation processing control, wherein the CPU 61 is connected with the ROM 62 and the RAM 63 via a bus.

The POS terminal 11 connects the CPU 61 by various input/output circuits (not shown) with the cash box 21, the keyboard 22, the display 23, the touch panel 26 and the customer-oriented display 24, which are all controlled by the CPU 61.

The keyboard 22 comprises decimal buttons 22d displaying numbers ‘1’, ‘2’, ‘3’ . . . or operators such as ‘*’, a temporary summing button 22e and a summing button 22f.

The POS terminal 11 connects the CPU 61 with a hard disk drive (HDD) 64, which is used for storing programs or documents. If the POS terminal 11 is activated, the CPU 61 copies all or part of the programs or documents stored in the HDD 64 into the RAM 63 where the copies are executed orderly. As an example, the program stored in the HDD 64 is a program PR for processing commodity sales data. As an example, the document stored in the HDD 64 is a stored PLU document F1 that is sent by a store computer SC. The PLU document F1, which corresponds to a commodity code allocated onto a commodity, is a document for storing commodity-related information such as name, unit price and category.

The POS terminal 11 connects the CPU 61 with the SC and a communication interface 25 for carrying out a data communication via input/output circuits (not shown). The store computer SC is installed in the background of a store installed with the cash register system 1 and provided with an HDD (not shown) for storing a PLU document F1 that is sent to the POS terminal 11.

The POS terminal 11 further connects the CPU 61 with a connection interface 65, which is configured to send and receive data between the POS terminal 11 and the code reading apparatus 101. The CPU of the POS terminal 11 acquires the commodity-specific information, such as commodity code, that is read via the code reading apparatus 101. Additionally, the CPU 61 records the commodities that are specified by the acquired commodity-specific information and recorded in sales. Therefore, the POS terminal 11 connects the connection interface 65 with the code reading apparatus 101. Besides, in the POS terminal 11, the CPU 61 is connected with a printer 66 for printing a bill. Under the control the CPU 61, the POS terminal 11 prints the content of a transaction on a bill via the printer.

The code reading apparatus 101 is also provided with a microcomputer 160, which comprises a CPU 161, an ROM 162 and an RAM 163, wherein the CPU 161 is connected with the ROM 162 and the RAM 163 via a bus. The ROM 162 stores a program executed by the CPU 161. In addition, in the code reading apparatus 101, the CPU 161 is connected with a photographing unit 164 via various input/output circuits (not shown) to control the motions of the photographing unit 164. Moreover, the code reading apparatus 101 connects a display/operation unit 104, of which the motions is controlled by the PU 61 of the POS terminal 11, with the POS terminal 11 via a connection interface 176.

The photographing unit 164 is a charge coupled device (CCD) imaging sensor or complementary metal oxide semiconductor (CMOS) imaging sensor and the like, which photographs an image from the reading window 103 under the control of the CPU 161. For instance, the photographing unit 164 photographs an image at a given frame rate (e.g. 30 fps).

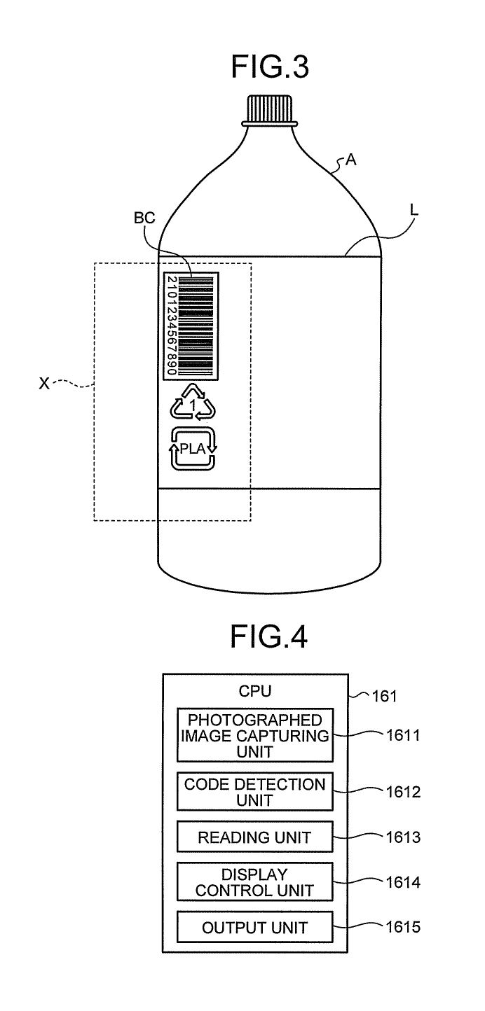

The relationship between a commodity processed by the code reading apparatus 101 related to this embodiment and the photographing area of the photographing unit 164 is explained here. FIG. 3 is a diagram of an example of the relationship between a commodity and the photographing area of a photographing unit. In FIG. 3, the area surrounded by dashed lines serves as a photographing area for the photographing unit 164 to take a 1-frame image. In a store selling the commodity A shown in FIG. 3, the commodity A is affixed with a label L printed with a bar code BC; the commodity-specific information, such as commodity code, of the specific commodity A is incorporated in the bar code BC as commodity information necessary for registering sales of the commodity A in the POS terminal 11; and the commodity code ‘2101234567890’ incorporated in the bar code BC is displayed under the bar code BC in the form of number.

Returning to FIG. 2, the code reading apparatus 101 is connected with the connection interface 65 of the POS terminal 11 to connect a connection interface 175 with the CPU 161, the connection interface 175 sending or receiving data to or from the POS terminal 11. The CPU 161 outputs, via the connection interface 175, the commodity code that is read from the bar code BC contained in the image photographed by the photographing unit 164 of the code reading apparatus 101, and thereby inputs the commodity code read from the bar code BC to the POS terminal 11 via the connection interface 65.

Secondarily, the functional unit of the code reading apparatus 101 that is realized by executing programs orderly with the CPU 161 is described below with reference to accompanying drawings. FIG. 4 is a block diagram of the functional structure of a CPU installed in a code reading apparatus. As shown in FIG. 4, by executing the programs stored in the ROM 162 orderly, the CPU 161 can function as a photographed image capturing unit 1611, a code detection unit 1612, a reading unit 1613, a display control unit 1614 and an output unit 1615.

The photographed image capturing unit 1611 sends a photography starting signal to the photographing unit 164 to drive the photographing unit 164 to take images, orderly reads the images photographed by the photographing unit 164 in the photographing area X, and stores the captured images in the RAM 163 in the photographing order of the photographing unit 164.

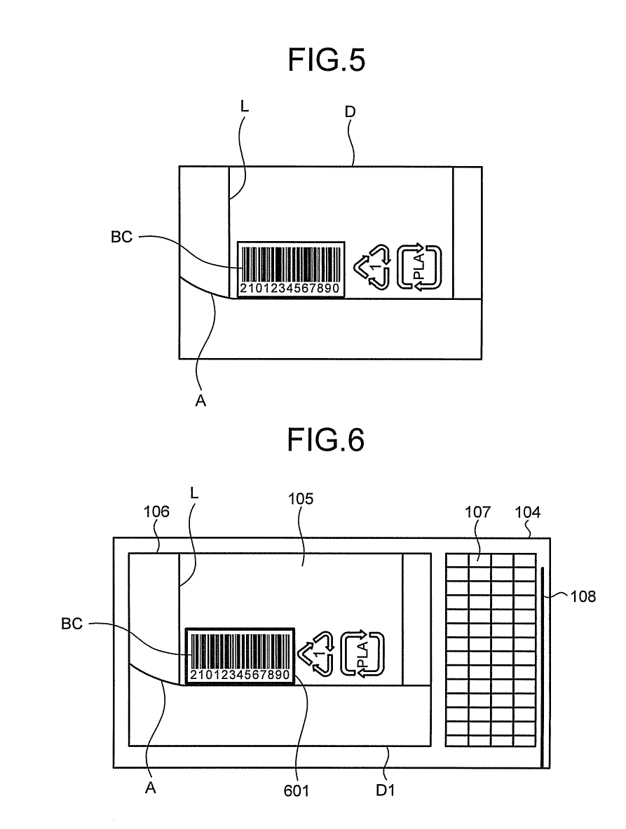

The image captured by the photographed image capturing unit 1611 is described below with reference to FIG. 5. FIG. 5 is a diagram of an example of an image captured by a photographed image capturing unit. As shown in FIG. 5, the photographed image capturing unit 1611 stores an image D corresponding to the photographing area X in the RAM 163.

The code detection unit 1612 detects a bar code BC according to the image D that is captured by the photographed image capturing unit 1611 and stored in the RAM 163. Specifically, the code detection unit 1612 detects a bar code BC according to the image D stored in the RAM 163 using an image matching technology, or detects a two-dimensional code according to a given searcher image.

In the case where a bar code BC is detected by the code detection unit 1612, the reading unit 1613 reads commodity-specific information such as commodity code from the bar code BC detected by the code detection unit 1612, and stores the read commodity-specific information in the RAM 163.

The outputting unit 1615 outputs the commodity-specific information stored in the 163 RAM to the POS terminal 11, which sales and records the commodity A according to the commodity-specific information acquired from the code reading apparatus 101. Specifically, by reference to the RLU document F1 on the basis of the commodity-specific information acquired from the code reading apparatus 101, the CPU 61 of the POS terminal 11 reads the information related to a commodity specified by the acquired commodity-specific information and further stores the read commodity-related information in a primary sales document, thereby selling and recording the commodities involved in a transaction.

The display control unit 1614 displays the information related to a commodity specified by the read commodity-specific information stored in the RAM 163 on a display 106 of the display/operation unit 104. For instance, the display control unit 1614 reads, from the FLU document F1 stored in the HDD 64 of the POS terminal 11, commodity-related information, such as such as name, unit price and category, which corresponds to the commodity code stored in the RAM 163. Moreover, the display control unit 1614 displays the read commodity-related information on the display 106 as the information related to a commodity specified by the commodity-specific information stored in the RAM 163.

In addition, the display control unit 1614 reads the image D that is captured by the photographed image capturing unit 1611 and stored in the RAM 163 during the period in which the reading unit 1613 reads the commodity-specific information. Moreover, the display control unit 1614 displays the read image D on the display 106 as the information related to a commodity specified by the commodity-specific information stored in the RAM 163. In this embodiment, the display control unit 1614 generates an image containing the borders surrounding the bar code BC detected by the code detection unit 1612 on the image D stored in the RAM 163 and displays the generated image on the display 106 as the information related to a commodity specified by the commodity-specific information stored in the RAM 163.

FIG. 6 is a diagram of an example of an image displayed on a display. The display control unit 1614 reads the image D that is captured by the photographed image capturing unit 1611 and stored in the RAM 163 if the reading of the commodity-specific information by the reading unit 1613 is started, detects the coordinates of the bar code BC contained in the detected image D, and then generates, on the read image D, an image D1 which is overlapped with the image D in the borders 601 surrounding the coordinates of the detected bar code BC and displays the generated image D1 on the display 106, thus enabling the operator to confirm the commodity-specific information that is being read from the bar code BC printed on the label L affixed on the commodity A.

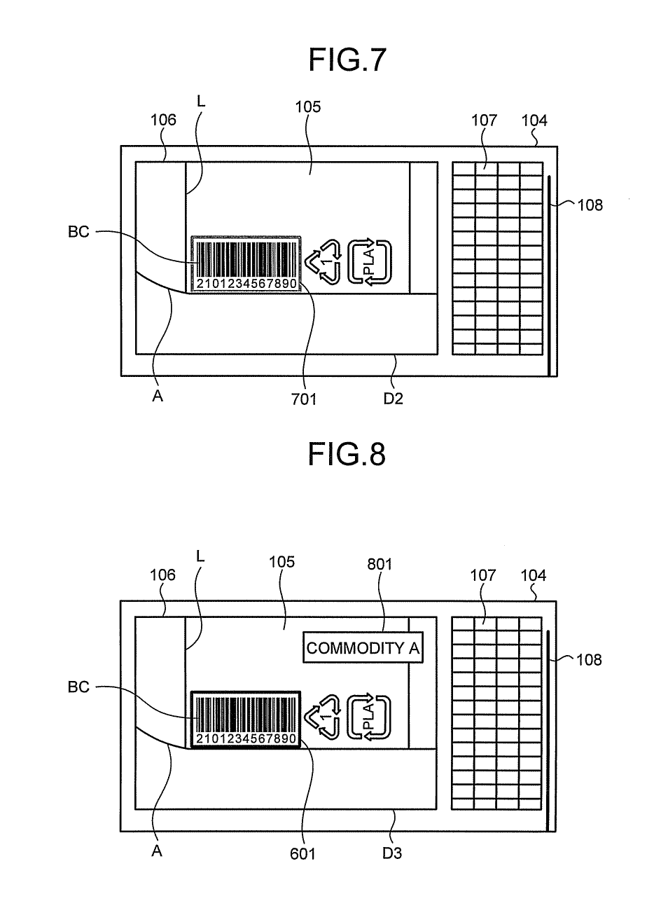

Further, while the reading unit 1613 is reading the commodity-specific information, the display control unit 1614 reads the commodity-specific information of a specific commodity that is recorded in sales in the same transaction. That is, before the summing button 22f on the keyboard 22 of the POS terminal 11 is pressed down, the display control unit 1614 reads the commodity-specific information of a specific commodity that is recorded in sales, and changes the display mode of the display 106 in the case where the commodity-specific information read by the reading unit 1613 is the same as that read from the POS terminal 11. FIG. 7 is a diagram of an example of a way for changing the display mode of a display. In this embodiment, if the read commodity-specific information is the same as the commodity information of a specific commodity that is recorded in sales in the same transaction, the display control unit 1614 displays, as shown in FIG. 7, an image D2 containing borders 701 with a color different from that of borders 601 (referring to FIG. 6) contained in the image D1 displayed on the display 106 on the same display, thereby changing the display mode of the display 106.

That is, in accordance with this embodiment, if the commodity-specific information acquired from the bar code BC of the commodity A is read twice, the image D2, which is different from the image D1 that is displayed on the display 106 if the bar code BC of the commodity A is read, is displayed on the same display to alert the operator to the repeated reading of the commodity-specific information of the commodity A, thereby enabling the operator to correct the commodity-specific information of the special commodity that is recorded in sales and avoid the repeated reading of the commodity-specific information. The commodity-specific information may be read twice in the following cases: the commodity A the commodity-specific information of which is already read is placed by an operator into the first shopping basket 153a again and then read in commodity-specific information again by the code reading apparatus 101; and the commodity-specific information of the commodity A is read again by the code reading apparatus 101 as the commodity A is slowly moved by the operator in the photographing area X of the photographing unit 164.

In addition, in this embodiment, if the read commodity-specific information is the same as the commodity-specific information of a specific commodity that is recorded in sales in the same transaction, the display control unit 1614 changes the display mode of the display 161 by displaying the image D2 which is changed in the color of the borders 601 if compared with the image D1 displayed on the display 106. For instance, the display control unit 1614 displays the image D stored in the RAM 163 via the photographing image capturing unit 1611 on the display 106 as the information related to a commodity specified by the commodity-specific information that is stored in the RAM 163 via the reading unit 1613. Moreover, the display control unit 1614 may change the display mode of the display 106 by displaying the image D1 containing the borders 1 surrounding the bar code BC on the image D displayed on the display 106.

Further, the display control unit 1614 reads, from the PLU document F1 stored in the HDD 64 of the POS terminal 11, commodity-related information such as name, unit price and category, and displays the read commodity-related information on the display 106 as the information related to a commodity specified by the commodity-related information stored in the RAM 163. Moreover, the display control unit 1614 may change the display mode of the display 106 by changing or flashing the color of the commodity-related information read from the PLU document F1 such as name, price and category.

FIG. 8 is a diagram of another example of a way for changing the display mode of a display. If the commodity-specific information read via the reading unit 1613 is the same as the commodity-specific information of a specific commodity that is recorded in sales in the same transaction, the display control unit 1614 reads, from the PLU document F1 stored in the HDD 64 of the POS terminal 11, the name of a commodity that is stored together with the commodity code that serves as the read commodity-specific information. Then, as shown in FIG. 8, the display control unit 1614 generates, on the image D1 displayed on the display 106, an image D3 which is overlapped with the image D1 in the read commodity name 801. Moreover, the display control unit 1614 may change the display mode of the display 106 by displaying the generated image D3 on the display 106.

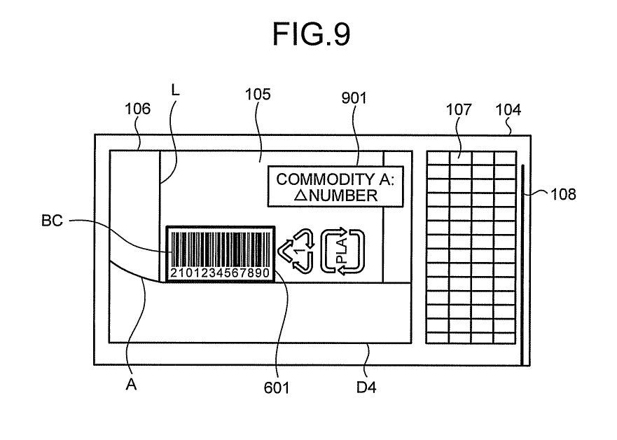

FIG. 9 is a diagram of another example of a way for changing the display mode of a display. If the commodity-specific information read via the reading unit 1613 is the same as the commodity-specific information of a specific commodity that is recorded in sales in the same transaction, the display control unit 1614 reads, from the POS terminal 11, the commodity-specific information that is the same as that read from the commodity-specific information of the commodity that is recorded in sales, and generates, as shown in FIG. 9, an image D4 containing the amount of the commodity-specific information read from the POS terminal 11 on the image D1 displayed on the display 106. Moreover, the display control unit 1614 may change the display mode of the display 106 by displaying the generated image D4 on the display 106. Thus, if the operator finds that the confirmed number of the purchased commodities is different from the number 901 contained in the image D4, the commodity-specific information that is recorded in sales can be corrected to avoid the repeated reading of the commodity-specific information.

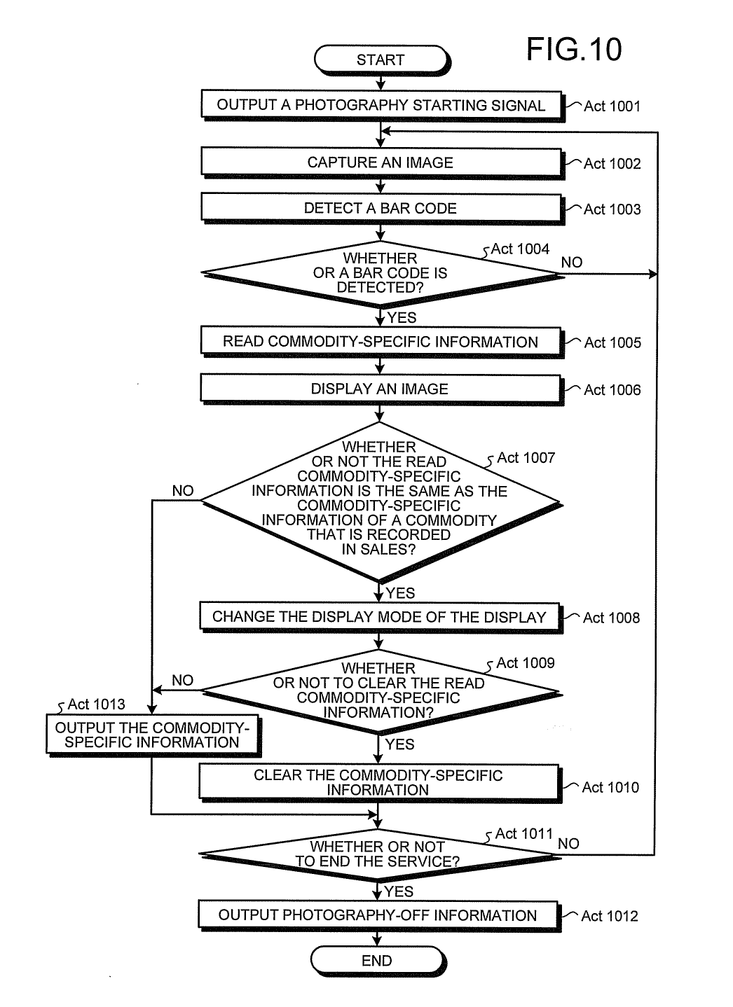

Below is description on the flow of the output processing of the commodity-specific information by the code reading apparatus 101. FIG. 10 is a flowchart for explaining the output processing of commodity-specific information by a code reading apparatus according to an embodiment.

If the POS terminal 11 starts to execute processing, for example, a commodity entry, the photographed image capturing unit 1811 outputs a photography starting signal to the photographing unit 164 to activate the photographing unit 164 to take an image (Act 1001), and then inputs the image D that is photographed by the photographing unit 164 and stored in the RAM 163 (Act 1002). Then, the code detection unit 1612 detects the bar code BC contained in the image captured by the photographed image capturing unit 1611 (Act 1003).

The reading unit 1613 determines whether or not a bar code is detected by the code detection unit 1612 (Act 1004), returns to execute Act 1002 if no bar code BC is detected (Act 1004: No) so that the photographed image capturing unit 1611 can capture a next image D, or reads the commodity-specific information contained in the detected bar code (Act 1005) if a bar code BC is detected (Act 1004: Yes). The display control unit 1614 displays the image D that is captured by the photographed image capturing unit 1611 on the display 106 (Act 1006) during the period in which the reading unit 1613 reads the commodity-specific information and determines whether or not the commodity-specific information read by the reading unit 1613 is the same as the commodity-specific information of a specific commodity that is recorded in sales by the POS terminal 11 in the same transaction (Act 1007).

In the case where the commodity-specific information read by the reading unit 1613 is the same as the commodity-specific information of the specific commodity that is recorded in sales in the same selling processing (Act 1007: Yes), the display control unit 1614 changes the display mode of the display unit 106 (Act 1008). If it is needed to change the display mode of the display 106, the CPU 161 presses down the button ‘clear’ on the keyboard 107 to clear, in a given period of time, the commodity-specific information that is read by the reading unit 1613 and stored in the RAM 163. If required to clear commodity-specific information in a given period of time (Act 1009: Yes), the CPU 161 clears, from the RAM 163, the commodity-specific information read via the reading unit 1613 (Act 1010). Then, the commodity-specific information that is read twice is output to the POS terminal 11, the CPU 61 of which prevents the commodity from being recorded in sales according to the commodity-specific information that is read twice in the code reading apparatus 101. That is, the CPU 61 of the POS terminal 11 can eliminate the repeatedly reading of the commodity-specific information before the commodity is recorded in sales in accordance with the repeatedly read commodity-specific information.

The output unit 1615 outputs the commodity-specific information read by the reading unit 1613 to the POS terminal 11 (Act 1013) if the commodity-specific information read by the reading unit 1613 is different from the commodity-specific information of a specific commodity that is recorded in sales in the same transaction (Act 1013: No). If not required to clear commodity-specific information in a given period of time (Act 1009: No), the output unit 1615 outputs the commodity-specific information that is read by the reading unit 1613 (Act 1013) to the POS terminal 11 (Act 1013). The CPU 61 of the POS terminal 11 reads the information related to a commodity specified by the input commodity-specific information by reference to the PLU document F1 on the basis of the input commodity-specific information. CPU 61 register the read commodity information in a primary sales document, thereby registering sales of the commodity with one-time transaction.

On the other hand, after the read commodity-specific information is cleared or output to the POS terminal 11 via the output unit 1615, the CPU 61 determines whether or not there is a notice indicative of the completion of a commodity entry output from the POS terminal 11 (Act 1011). In addition, it is provided that a notice indicative of the completion of a commodity entry is output after the POS terminal 11 presses down the summing button 22f on the keyboard 22. In the case where the service is continued (Act 1011: No), the flow returns to Act 1002 so that the photographed image capturing unit 1611 can input a next image D. If the service is ended (Act 1011: Yes), the photographed image capturing unit 1611 sends a photography-off signal to the photographing unit 164 to stop the photography of the photographing unit 164 (Act: 1012).

By photographing an image D, capturing the photographed image D, detecting and displaying the bar code BC representing the commodity-specific information of a specific commodity recorded in sales according to the captured photographed image, reading the commodity-specific information from the detected bar code BC, displaying the information related to the read commodity-specific information on the display 106, and changing the display mode of the display 106 if the read commodity-specific information is the same as the commodity-specific information of a specific commodity that is recorded in sales in the same transaction, the cash register system 1 related to this embodiment alerts the operator to the repeated reading of the commodity-specific information of a commodity A so that the commodity-specific information that is incorrectly recorded twice in sales can be corrected to avoid the repeated reading of the commodity-specific information.

Additionally, the programs executed in the POS terminal 11 and the code reading apparatus 101 are incorporated and provided in the ROM in advance in this embodiment, however, it should be appreciated that these programs may be provided while being recorded in a computer-readable recording medium such as a CR-ROM, a flexible disk (FD), a CD-R, or a DVD (Digital Versatile Disk) as a file of an installable format or an executable format.

Further, the programs executed in the POS terminal 11 and the code reading apparatus 101 may be stored on a computer connected to a network such as the Internet and provided by being downloaded through the network or provided or distributed through the network such as the Internet.

In the present invention, the programs executed in the code reading apparatus 101 become modular structures comprising the foregoing units (the photographed image capturing unit 1611, the code detection unit 1612, the reading unit 1613, the display control unit 1614 and the output unit 1615), and are read and executed as an actual hardware from the ROM via the CPU to download each foregoing unit to a primary storage device and generate the photographed image capturing unit 1611, the code detection unit 1612, the reading unit 1613, the display control unit 1614 and the output unit 1615 on the primary storage apparatus.

Further, in this embodiment, in addition to the CPU 161 of the code reading apparatus 101, the CPU 61 of the POS terminal 11 may still possess the functions of the photographed image capturing unit 1611, the code detection unit 1612, the reading unit 1613, the display control unit 1614 and the output unit 1615.

Further, in this embodiment, in addition to the CPU 161 of the code reading apparatus 101, the CPU 61 of the POS terminal 11 and the code reading apparatus 101 may still respectively possess the functions of the photographed image capturing unit 1611, the code detection unit 1612, the reading unit 1613, the display control unit 1614 and the output unit 1615.

Further effects and modifications can be easily derived by those skilled in the art. Therefore, broader aspects of the present embodiment are not limited to the specific details and the representative embodiment shown and described herein. Therefore, various alterations are possible without departing from the spirit or the scope of the general concept of the present embodiment defined by the appended claims or equivalents of the claims.

What is claimed is:

1. A code reading apparatus, comprising:
a photographing unit configured to photograph an image;
a detection unit configured to detect a code symbol representing a commodity-specific information of a specific commodity that is recorded in sales based on the photographed image;
a reading unit configured to read the commodity-specific information from the detected code symbol;
a display unit configured to display the information related to a commodity specified by the read commodity-specific information; and
a display control unit configured to change the display mode of the display unit if the read commodity-specific information is the same as the commodity-specific information of a specific commodity that is recorded in sales in the same transaction.

2. The code reading apparatus according to claim 1, wherein
the display unit displays the photographed image as the information related to a commodity specified by the read commodity-specific information.

3. The code reading apparatus according to claim 2, wherein
if the read commodity-specific information is the same as the commodity-specific information of a specific commodity that is recorded in sales in the same transaction, the display control unit changes the display mode of the display unit by enabling the displayed image to contain the borders surrounding the detected code symbol.

4. The code reading apparatus according to claim 2, wherein
if the read commodity-specific information is the same as the commodity-specific information of a specific commodity that is recorded in sales in the same transaction, the display control unit changes the display mode of the display unit by superposing the names of the commodities specified by the read commodity-specific information on the displayed image.

5. The code reading apparatus according to claim 1, wherein
if the read commodity-specific information is the same as the commodity-specific information of a specific commodity that is recorded in sales in the same transaction, the display control unit changes the display mode of the display unit by displaying the number of the commodities that are specified by the read commodity-specific information and recorded in sales in the same transaction.

6. The code reading apparatus according to claim 1, wherein
the display unit displays an image containing the borders surrounding the detected code symbol on the photographed image; and
if the read commodity-specific information is the same as the commodity-specific information of a specific commodity that is recorded in sales in the same transaction, the display control unit changes the display mode of the display unit by replacing the displayed image with an image which is different from the displayed image in the color of the borders.

7. A code reading system, comprising:
a capturing unit configured to capture a photographed image;
a detection unit configured to detect a code symbol representing a commodity-specific information of a specific commodity that is recorded in sales based on the captured image;
a reading unit configured to read the commodity-specific information from the detected code symbol;
a display unit configured to display the information related to a commodity specified by the read commodity-specific information; and
a display control unit configured to change the display mode of the display unit if the read commodity-specific information is the same as the commodity-specific information of a specific commodity that is recorded in sales in the same transaction.

8. The code reading system according to claim 7, wherein
the display unit displays the captured image as the information related to a commodity specified by the read commodity-specific information.

9. A code reading method comprising:
capturing a photographed image;
detecting a code symbol representing a commodity-specific information of a specific commodity that is recorded in sales based on the captured image;
reading the commodity-specific information from the detected code symbol;
displaying the information related to a commodity specified by the read commodity-specific information on a display unit; and
changing the display mode of the display unit if the read commodity-specific information is the same as the commodity-specific information of a specific commodity that is recorded in sales in the same transaction.

10. The code reading method according to claim 9, wherein
the captured image is displayed on the display unit as the information related to a commodity specified by the read commodity-specific information.
